(19) United States
(12) Patent Application Publication
(10) Pub. No.: US 2020/0015939 A1
(43) Pub. Date: Jan. 16, 2020

(54) Orthodontic Appliance for Use During Orthognathic Surgery and Method for Using the Same

(71) Applicant: Bella Shen Garnett, San Francisco, CA (US)

(72) Inventor: Bella Shen Garnett, San Francisco, CA (US)

(21) Appl. No.: 16/031,356

(22) Filed: Jul. 10, 2018

(51) Int. Cl. A61C 7/20; A61C 7/30; A61C 7/36; A61C 7/14; A61C 7/18

(52) U.S. Cl. CPC A61C 7/20; A61C 7/303; A61C 7/08; A61C 7/148; A61C 7/18; A61C 7/36

(57) ABSTRACT

A device and method for performing orthodontic decompensation before orthognathic surgery without the aid of braces. The device includes an archwire coupled at either end to a band which is in turn adhered to the first molars of a patient. Disposed along the length of the archwire is a plurality of fixtures which may include a plurality of hooks that work in conjunction with elastics or other components used during the orthognathic procedure. The archwire is formed around the patient's teeth so as to be passive and maintain the patient's current orthodontic treatment progress. The device may be placed on either or both of the upper and lower teeth of the patient before the orthognathic procedure thereby ensuring that the teeth will not move during or after the surgery during the recovery process and that required surgical splints will still fit.

### BACKGROUND

### Field of the Technology

The invention relates to the field of orthodontic appliances, specifically orthodontic appliances which may be used in conjunction with orthognathic procedures.

### Description of the Prior Art

Orthognathic surgery, or corrective jaw surgery, has long been used by oral surgeons to correct a number of oral or dental defects experienced by patients including everything from correcting bite fit to repairing facial injuries. In most types of orthognathic procedures, the oral surgeon inserts a variety of bone plates, screws, and wires to adjust the position of the patient's jaw bone or insert a new bone into the patient's facial region. After the procedure, the patient may also have their jaw wired shut until the healing and recovery phase has been completed which can often last up to 6-12 weeks.

For many orthognathic surgeries, the teeth need to fit together at the end of the procedure. Usually teeth are aligned before surgery, sometimes with the use of braces, but it can also be done after. Regardless, the jaws need to be held together during the surgery. Many oral surgeons typically use braces with hooks and screws in the jaws, specifically mandibulo-maxillary fixation (MMF) screws, all of which costs more time and be can invasive to the patient. Other treatments include bonding buttons to the teeth, however these buttons can break and since they are not attached to anything else, patients are at risk for aspirating the brackets. Aligners have also been used to effectuate a patient's orthodontic treatment, however since the aligners must be placed in the patient's mouth to work, aligners cannot be used while the patient's jaw is wired shut. Additionally, orthognathic surgeons typically bond bars or wires to the teeth, however these wires can then fall off completely once one or two teeth are no longer bonded.

A problem arises therefore for those orthognathic patients who use or wish to use aligners to reposition their teeth in order to have the orthognathic surgery. Typically, since the patient's jaws must be wired shut post-surgery, a patient must undergo orthodontic decompensation using traditional braces in order to ensure that the patient's teeth are in the proper position before and after the surgery is performed. Knowing that braces are mandatory and can be much more invasive than aligners, many patients wishing to use aligners instead will opt out of the having the orthognathic procedure all together, thereby depriving themselves of needed orthognathic treatment.

What is needed therefore is a device and method which allows a patient undergoing orthodontic decompensation to use an aligner treatment regimen before and after the orthognathic procedure. The device and method should not interfere with the appliances required for the patient's recovery and should enable the patient to use an aligner treatment regimen in order to move the patient's teeth into a position where the orthognathic procedure can be performed, thereby ensuring a proper bite is achieved without the need of braces. The device and method should also be coupled to the back teeth of the patient in order to minimize the possibility that any components are broken during the surgical procedure. Additionally, the device and method should be less painful and invasive than traditional braces while improving the bite fit or occlusion of the patient.

### BRIEF SUMMARY

The current invention is an orthodontic device for use in conjunction with a patient undergoing an orthognathic procedure. The orthodontic device includes an archwire and a plurality of bands coupled to the archwire, wherein at least one band is coupled to either lateral end of the archwire. The device further includes a plurality of fixtures symmetrically that are disposed along the length of the archwire.

In one embodiment, the plurality of fixtures includes a plurality of hooks.

In another embodiment, the plurality of bands are configured to be cemented to the first molars of the patient.

In a related embodiment, the archwire is configured to be bonded to a plurality of the patient's teeth.

In one embodiment, each of the plurality of bands coupled to archwire have a bracket configured to accommodate the archwire.

In yet another embodiment, the archwire is contoured or formed around a plurality of the patient's teeth, the specific contour configured to be passive relative to the patient's teeth.

In one specific embodiment, the plurality of fixtures disposed on the archwires accommodate a corresponding plurality of elastics.

The invention also includes a method for performing orthodontic decompensation before an orthognathic procedure without the use of braces, the method itself includes applying at least one aligner to the upper or lower teeth of the patient before the orthognathic procedure is performed, removing the at least one aligner from the teeth of the patient, and then coupling a first archwire to a corresponding first pair of bands and coupling a second archwire to a corresponding second pair of bands. Specifically, the first pair of bands are cemented to a pair of upper first molars while the second pair of bands are cemented to a pair of lower first molars of the patient. The first and second archwires are then formed about a plurality of the patient's upper and lower teeth, respectively. The orthognathic procedure is then performed which is followed by wiring the jaw of the patient shut by coupling the first archwire to the second archwire. Next, after the patient has had a chance to heal, the first and second archwires and the first and second pairs of bands are removed from the teeth of the patient, thereby allowing the patient to reapply the at least one aligner to their upper and/or lower teeth.

In one embodiment, the method step of coupling the first archwire to the first pair of bands and coupling the second archwire to the second pair of bands includes welding each archwire to the respective pair of bands.

In a related embodiment, the method step of coupling the first archwire to the first pair of bands and coupling the second archwire to the second pair of bands includes disposing the lateral ends of the first and second archwires through a bracket disposed on each of the first and second pairs of bands.

In another embodiment, the method step of forming the first and second archwires about a plurality of the patient's upper and lower teeth includes contouring the first and second archwires about the upper and lower teeth so that the first and second archwires are configured to be passive on the upper and lower teeth, respectively. In this embodiment, the first archwire is bonded to each of the upper teeth of the patient while the second archwire is bonded to each of the lower teeth of the patient.

In another embodiment, the method step of wiring the jaw of the patient shut by coupling the first archwire to the second archwire includes coupling a plurality of elastics to a plurality of fixtures disposed along the length of the first archwire and then coupling the same plurality of elastics to a plurality of fixtures disposed along the length of the second archwire.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is an elevated side view of the current device as applied to the lower jaw of a patient.

FIG. 2 is a frontal view of the device seen in FIG. 1.

FIG. 3 is a top down view of the device seen in FIG. 1.

FIG. 4A is a plan view of the upper teeth of a patient prior to undergoing an orthognathic procedure.

FIG. 4B is a plan view of the lower teeth of a patient prior to undergoing an orthognathic procedure.

FIG. 4C is a side view of the right side of the teeth of a patient prior to undergoing an orthognathic procedure.

FIG. 4D is a frontal view of the front of the teeth of a patient prior to undergoing an orthognathic procedure.

FIG. 4E is a side view of the left side of the teeth of a patient prior to undergoing an orthognathic procedure.

FIG. 5A is a plan view of the upper teeth of the patient after the current device has been applied to their upper teeth.

FIG. 5B is a plan view of the lower teeth of a patient after the current device has been applied to their lower teeth.

FIG. 5C is a side view of the right side of the teeth of a patient after the current device has been applied to their upper and lower teeth.

FIG. 5D is a frontal view of the front of the teeth of a patient after the current device has been applied to their upper and lower teeth.

FIG. 5E is a side view of the left side of the teeth of a patient after the current device has been applied to their upper and lower teeth.

FIG. 6A is a plan view of the upper teeth of a patient after undergoing an orthognathic procedure and having the current device removed from their upper teeth.

FIG. 6B is a plan view of the lower teeth of a patient after undergoing an orthognathic procedure and having the current device removed from their lower teeth.

FIG. 6C is a side view of the right side of the teeth of a patient after undergoing an orthognathic procedure and having the current device removed from their upper and lower teeth.

FIG. 6D is a frontal view of the front of the teeth of a patient after undergoing an orthognathic procedure and having the current device removed from their upper and lower teeth.

FIG. 6E is a side view of the left side of the teeth of a patient after undergoing an orthognathic procedure and having the current device removed from their upper and lower teeth.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

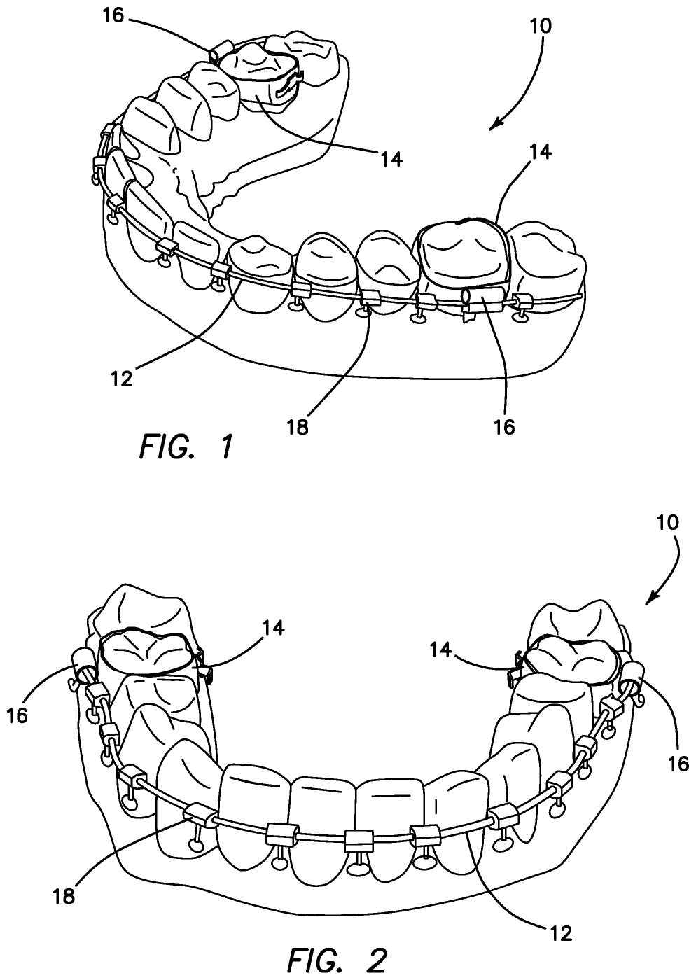

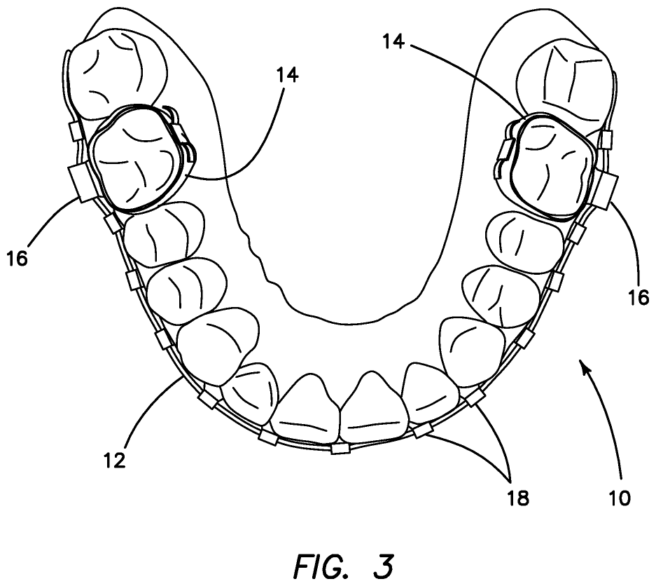

Greater detail of the current invention may be seen in FIGS. 1-3 where the current orthodontic device is shown and which is denoted generally by reference numeral 10. The device 10 comprises a rectangular 19×25 stainless steel archwire 12 disposed or formed passively about the patient's upper and/or lower teeth. The archwire 12 is coupled to a band 14 disposed at either lateral end of the archwire 12 via a corresponding bracket 16 that is coupled to each respective band 14. The archwire 12 is preferably soldered to the bracket 16 of each band 14. Each band 14 is cemented to the patient's first molar as is known in the art. The archwire 12 extends through the bracket 16 past the first molar to the second molar as best seen in FIGS. 1 and 3.

The archwire 12 is specifically contoured or formed so as to be passive on the teeth, or in other words, the archwire 12 does not apply excessive force or further align or level the patient's teeth. The archwire 12 further comprises a plurality of fixtures 18 which are symmetrically disposed along the length of the archwire 12. In one particular embodiment, each appliance or fixture 18 is soldered to the archwire 12 and then the archwire 12 itself is bonded to each of the patient's teeth with a composite as is known in the art. In one preferred embodiment, each of the plurality of fixtures 18 is disposed along the length of the archwire 12 so as to be substantially disposed between at least two teeth. The fixtures 18 may be any suitable dental or orthodontic appliance now known or later devised which is capable of being coupled to an archwire and which allows the patient to wear elastics after an orthognathic procedure to help refine their bite while their jaw has been wired shut. In one particular embodiment, the fixtures 18 may comprise a plurality of surgical ball hooks, square ball hooks, or hooks comprising a portion of soldered metal disposed on them to decrease their sharpness, however it is to be expressly understood that additional or different fixtures which assist the surgeon in placing elastics in order to hold the patient's jaws in place post-surgery which are not explicitly disclosed herein may be used without departing from the original spirit and scope of the invention. In another preferred embodiment, each of the fixtures 18 comprises a post which is 3-7 mm long. Each fixture 18 further comprises a substantially rounded or curved shape coupled or soldered to the tip of each post so as to cover or blunt any undesirable sharp edges or points. An elastic may then be placed over the rounded tip of each fixture 18, thereby helping to hold the patient's jaw shut while preventing each fixture 18 from cutting the patient's gums or causing injury.

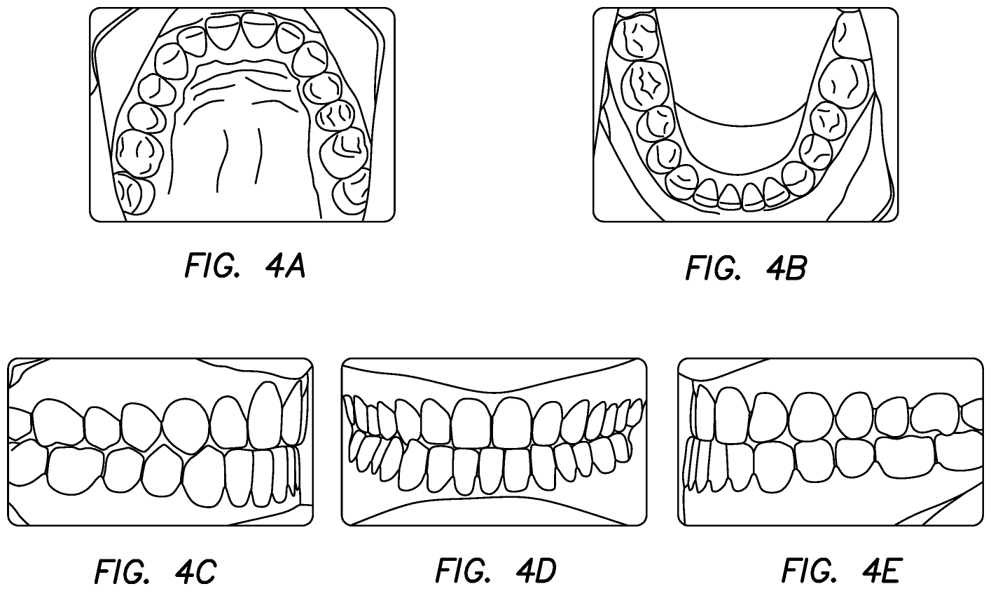

Use of the device 10 may be had by turning to FIGS. 4-6. FIGS. 4A-4E show multiple angles of a patient's mouth and teeth before an orthognathic procedure has been performed. As can be seen by the several views, the patient's teeth are slightly misaligned which negatively impacts the patient's bite profile. Prior to the orthognathic procedure, the patient may undergo an orthodontic treatment regimen using a series of aligners as is known in the art so as to level and align their teeth prior to the surgery, thus avoiding the need for applying traditional braces to the patient's teeth months before the procedure is performed.

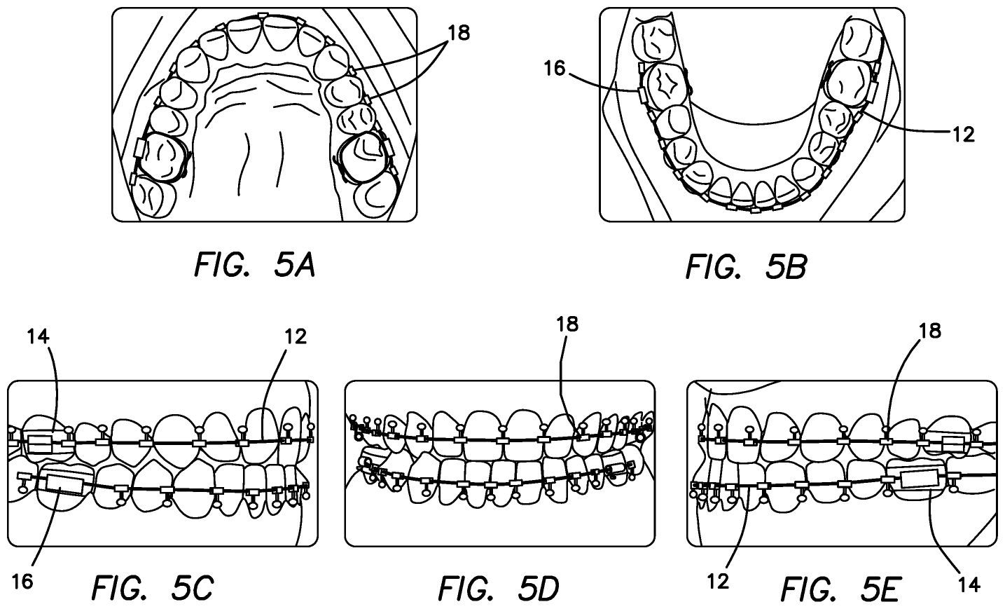

FIGS. 5A-5E show multiple angles of the patient's mouth and teeth after a device 10 has been applied to the patient's upper and lower teeth in the manner discussed above. It is important to note that the specific placement of the devices 10 shown in FIGS. 5A-5E is meant for illustrative purposes only and that alternative placements, combinations of orthodontic fixtures, or configurations may be used within the scope of the disclosure. The relative ease in which the device 10 may be applied to the patient's teeth allows the device 10 to be placed the day before the orthognathic surgery is to be performed, thereby not only allowing the patient to continue their aligner regimen for as long as possible, but also ensuring that the teeth do not move before the surgery and that the surgical splints used during the surgery will still fit. Once properly placed, the devices 10 ensure that that patient's teeth are held in place, thereby enabling the surgeon to wire the jaws shut and in position while they place the rigid fixations plates and screws. The placement of the devices 10 also allow the orthognathic surgeon to perform the procedure since the surgeon cannot do the surgery without a structure fixated on the patient's upper and lower jaws. In one particular embodiment, the surgeon wires the patient's mouth shut by coupling a plurality of elastics between the fixtures 18 disposed on the archwire 12 installed on the patient's upper teeth to the fixtures 18 disposed on the archwire 12 installed on the patient's lower teeth. The elastics also help settle the patient's bite by bringing the teeth together and holding the bite and occlusion after the surgery. Once the patient heals, the appliance is removed and the patient can be rescanned if needed to refine the bite and continue their aligner treatment. In some cases, the bite will be good after the surgery and the appliance can be removed and the patient can be placed in retainers.

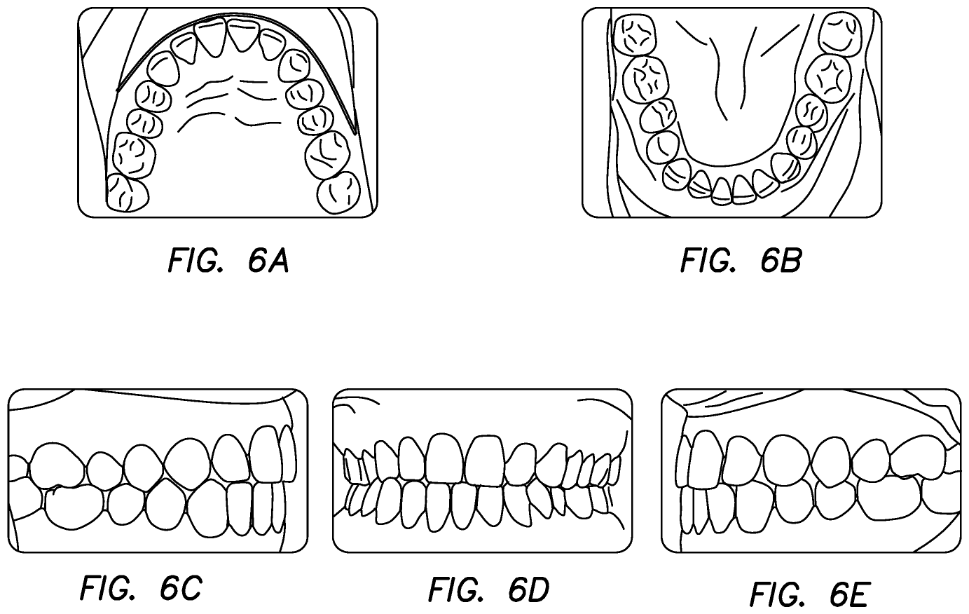

FIGS. 6A-6E show multiple angles of the patient's mouth and teeth after the orthognathic procedure has been performed and after the devices 10 have been removed following the patient's recovery. Specifically, a few weeks after the orthognathic procedure, the patient's jaws may be reopened by the surgeon and the devices 10 removed from the patient's teeth. The patient is then free to continue their pre-surgery orthodontic treatment regimen by replacing their aligner and then continuing the refinement of their bite if needed. In some cases, the use of the current device 10 can help improve the patient's bite or occlusion to such a degree that aligners are not needed and instead retainers can be used to complete the patient's treatment regimen.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. An orthodontic device for use in conjunction with a patient undergoing an orthognathic procedure, the orthodontic device comprising:
an archwire;
a plurality of bands coupled to the archwire, wherein at least one band is coupled to either lateral end of the archwire; and
a plurality of fixtures symmetrically disposed along a length of the archwire.

2. The device of claim 1 wherein the plurality of fixtures each comprises a post, wherein the post comprises a rounded shape coupled to a tip of the post.

3. The device of claim 1 wherein the plurality of bands are configured to be cemented to the first molars of the patient.

4. The device of claim 1 wherein the archwire is configured to be bonded to a plurality of the patient's teeth.

5. The device of claim 1 wherein the plurality of bands coupled to archwire comprise a bracket configured to accommodate the archwire.

6. The device of claim 1 wherein the archwire comprises a contour formed around a plurality of the patient's teeth, the contour configured to be passive relative to the patient's teeth.

7. The device of claim 1 wherein the plurality of fixtures accommodate a corresponding plurality of elastics.

8. A method for performing orthodontic decompensation before an orthognathic procedure without using braces comprising:
applying at least one aligner to the upper or lower teeth of the patient before the orthognathic procedure is performed;
removing the at least one aligner from the teeth of the patient;
coupling a first archwire to a corresponding first pair of bands and coupling a second archwire to a corresponding second pair of bands;
cementing the first pair of bands to a pair of upper first molars and cementing the second pair of bands to a pair of lower first molars of the patient;
forming the first and second archwires about a plurality of the patient's upper and lower teeth;
wiring the jaw of the patient shut by coupling the first archwire to the second archwire;
performing the orthognathic procedure;
removing the first and second archwires and the first and second pairs of bands from the teeth of the patient; and
reapplying the at least one aligner to the upper or lower teeth of the patient.

9. The method of claim 8 wherein coupling the first archwire to the first pair of bands and coupling the second archwire to the second pair of bands comprises soldering each archwire to the respective pair of bands.

10. The method of claim 8 wherein coupling the first archwire to the first pair of bands and coupling the second archwire to the second pair of bands comprises disposing the lateral ends of the first and second archwires through a bracket disposed on each of the first and second pairs of bands.

11. The method of claim 8 wherein forming the first and second archwires about a plurality of the patient's upper and lower teeth comprises contouring the first and second archwires about the upper and lower teeth so that the first and second archwires are configured to be passive on the upper and lower teeth, respectively.

12. The method of claim 11 further comprising bonding the first archwire to each of the upper teeth of the patient and bonding the second archwire to each of the lower teeth of the patient.

13. The method of claim 8 wherein wiring the jaw of the patient shut by coupling the first archwire to the second archwire comprises:
coupling a plurality of elastics to a plurality of fixtures disposed along the length of the first archwire; and
coupling the plurality of elastics to a plurality of fixtures disposed along the length of the second archwire.

14. The method of claim 8 wherein forming the first and second archwires about a plurality of the patient's upper and lower teeth comprises symmetrically disposing a plurality of fixtures along a length of the first and second archwires, wherein each of the plurality of fixtures is disposed between at least two of the patient's teeth.

15. The method claim 13 wherein coupling a plurality of elastics to a plurality of fixtures disposed along the length of the first archwire and coupling the plurality of elastics to a plurality of fixtures disposed along the length of the second archwire comprises:
disposing at least one of the plurality of elastics around a curved tip of at least one of the plurality of fixtures along the length of the first archwire; and
disposing the at least one of the plurality of elastics around a curved tip of at least one of the plurality of fixtures along the length of the second archwire.
